(19) United States
(12) Patent Application Publication
(10) Pub. No.: US 2025/0173752 A1
(43) Pub. Date: May 29, 2025

(54) ANALYSIS APPARATUS, ANALYSIS METHOD, AND STORAGE MEDIUM

(71) Applicant: NEC Corporation, Minato-ku, Tokyo (JP)

(72) Inventors: Daichi Matsuoka, Tokyo (JP); Yoshihisa Honda, Tokyo (JP); Yuzuru Okajima, Tokyo (JP); Keisuke Tsukahara, Tokyo (JP)

(73) Assignee: NEC Corporation, Minato-ku, Tokyo (JP)

(21) Appl. No.: 18/839,795

(22) PCT Filed: Feb. 28, 2022
(86) PCT No.: PCT/JP2022/008344

§ 371 Date: Aug. 20, 2024

(51) Int. Cl. G06Q 30/0204

(52) U.S. Cl. CPC G06Q 30/0205

(57) ABSTRACT

To make it possible to suitably ascertain the behavioral tendency of a subject, an analysis apparatus (1) includes a determination section (11) that determines, from behavior history information of a subject, a plurality of factors of change in behavioral tendency of the subject based on behaviors before and after the factors; and a presentation section (12) that presents in chronological order the factors determined by the determination section (11).

### TECHNICAL FIELD

The present invention relates to an analysis apparatus and the like for analyzing a behavior of a subject.

### BACKGROUND ART

Conventionally, attempts have been made to analyze a subject's behavior to obtain useful knowledge. For example, Patent Literature 1 mentioned below discloses an analysis apparatus that analyzes a customer's purchase behavior to determine the environment in which a commodity product purchased by the customer was placed. Since the analysis apparatus disclosed in Patent Literature 1 makes it possible to determine the environment in which the product purchased by the customer was placed, it is possible to associate the environment in which the product was placed with purchase circumstances, and to infer a difference in effects of measures for sales promotion of the product.

### CITATION LIST

### Patent Literature

### Patent Literature 1

Japanese Patent Application Publication Tokukai No. 2021-177322

### SUMMARY OF INVENTION

### Technical Problem

However, the technique disclosed in Patent Literature 1 merely makes it possible to determine the environment in which the product purchased by a customer was placed, and thus it is impossible to ascertain the behavioral tendency of a subject. An example aspect of the present invention has been made in view of this problem, and an example object thereof is to provide a technique capable of suitably ascertaining the behavioral tendency of a subject.

### Solution to Problem

An analysis apparatus in accordance with an example aspect of the present invention includes: determination means for determining, from behavior history information of a subject, a plurality of factors of change in behavioral tendency of the subject based on behaviors before and after the factors; and presentation means for presenting in chronological order the factors determined by the determination means.

An analysis method in accordance with an example aspect of the present invention includes: determining, by at least one processor, from behavior history information of a subject, a plurality of factors of change in behavioral tendency of the subject based on behaviors before and after the factors; and presenting, by the at least one processor, the determined factors in chronological order.

An analysis program in accordance with an example aspect of the present invention causes a computer to function as: determination means for determining, from behavior history information of a subject, a plurality of factors of change in behavioral tendency of the subject based on behaviors before and after the factors; and presentation means for presenting in chronological order the factors determined by the determination means.

### Advantageous Effects of Invention

In accordance with an example aspect of the present invention, it is possible to suitably ascertain the behavioral tendency of a subject.

### BRIEF DESCRIPTION OF DRAWINGS

FIG. 1 is a block diagram illustrating the configuration of an analysis apparatus in accordance with a first example embodiment of the present invention.

FIG. 2 is a flowchart illustrating the flow of an analysis method in accordance with a second example embodiment of the present invention.

FIG. 3 is a block diagram illustrating an example of the configuration of the main part of an analysis apparatus in accordance with a second example embodiment of the present invention.

FIG. 4 is a diagram illustrating an example of training data and prediction rules generated from the training data.

FIG. 5 is a diagram illustrating an example in which some prediction rules are selected from among a set of prediction rules.

FIG. 6 is a diagram illustrating a presentation example of factors.

FIG. 7 is a diagram illustrating another presentation example of factors.

FIG. 8 is a flowchart illustrating an example of processing carried out by the analysis apparatus in accordance with the second example embodiment of the present invention.

FIG. 9 is a diagram illustrating an example of a computer that executes instructions of a program which is software implementing the functions of the apparatuses in accordance with the example embodiments of the present invention.

### EXAMPLE EMBODIMENTS

### First Example Embodiment

A first example embodiment of the present invention will be described in detail with reference to the drawings. The present example embodiment is an embodiment serving as a basis for example embodiments described later.

### (Configuration of Analysis Apparatus)

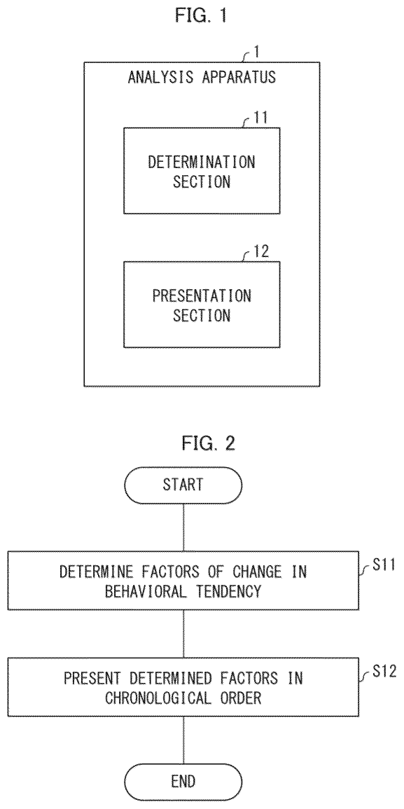

The configuration of an analysis apparatus 1 in accordance with the present example embodiment will be described with reference to FIG. 1. FIG. 1 is a block diagram illustrating the configuration of the analysis apparatus 1. As illustrated in FIG. 1, the analysis apparatus 1 includes a determination section (determination means) 11 and a presentation section (presentation means) 12.

The determination section 11 determines, from behavior history information of a subject, a plurality of factors of change in behavioral tendency of the subject based on behaviors before and after the factors. The presentation section 12 presents in chronological order the factors determined by the determination section 11.

As described in the foregoing, the analysis apparatus 1 in accordance with the present example embodiment employs a configuration of including: the determination section 11 that determines, from behavior history information of a subject, a plurality of factors of change in behavioral tendency of the subject based on behaviors before and after the factors; and the presentation section 12 that presents in chronological order the factors determined by the determination section 11. Thus, according to the analysis apparatus 1 in accordance with the present example embodiment, it is possible to achieve an example advantage of being capable of suitably ascertaining the behavioral tendency of a subject.

### (Analysis Program)

The foregoing functions of the analysis apparatus 1 may be implemented by a program. An analysis program in accordance with the present example embodiment causes a computer to function as: determination means for determining, from behavior history information of a subject, a plurality of factors of change in behavioral tendency of the subject based on behaviors before and after the factors; and
presentation means for presenting in chronological order the factors determined by the determination means. According to the analysis program, it is possible to achieve an example advantage of being capable of suitably ascertaining the behavioral tendency of a subject.

### (Flow of Analysis Method)

The following description will discuss the flow of an analysis method S1 in accordance with the present example embodiment with reference to FIG. 2. FIG. 2 is a flowchart illustrating the flow of the analysis method S1. It should be noted that steps of the analysis method may be carried out by a processor of the analysis apparatus 1 or by a processor of another apparatus. Alternatively, the steps may be carried out by processors provided in respective different apparatuses.

In S11, at least one processor determines, from behavior history information of a subject, a plurality of factors of change in behavioral tendency of the subject based on behaviors before and after the factors.

In S12, the at least one processor presents the determined factors in chronological order.

As described in the foregoing, the analysis method S1 in accordance with the present example embodiment employs a configuration of including: determining, by at least one processor, from behavior history information of a subject, a plurality of factors of change in behavioral tendency of the subject based on behaviors before and after the factors (S11); and presenting, by the at least one processor, the determined factors in chronological order (S12). Thus, according to the analysis method S1 in accordance with the present example embodiment, it is possible to achieve an example advantage of being capable of suitably ascertaining the behavioral tendency of a subject.

### Second Example Embodiment

The following description will discuss a second example embodiment of the present invention in detail with reference to the drawings. In the present example embodiment, the following description will discuss, as an example of behavior history information described in the first example embodiment, an example in which purchase history information indicative of histories of purchase behaviors of a plurality of subjects is used and factors of an increase in purchase amount per predetermined period of the subjects are determined. Note, however, that the processing described below is not limited to determination of factors that have increased purchase amounts of a plurality of subjects, and the processing is available for determination of any factor with use of any behavior history information for any number of subjects. Thus, the “purchase history information” in the following description can be read as any behavior history information. The “purchase behavior” can be read as any behavior. The “change in purchase amount tendency” can be read as any change in tendency of behavior.

### (Configuration of Analysis Apparatus)

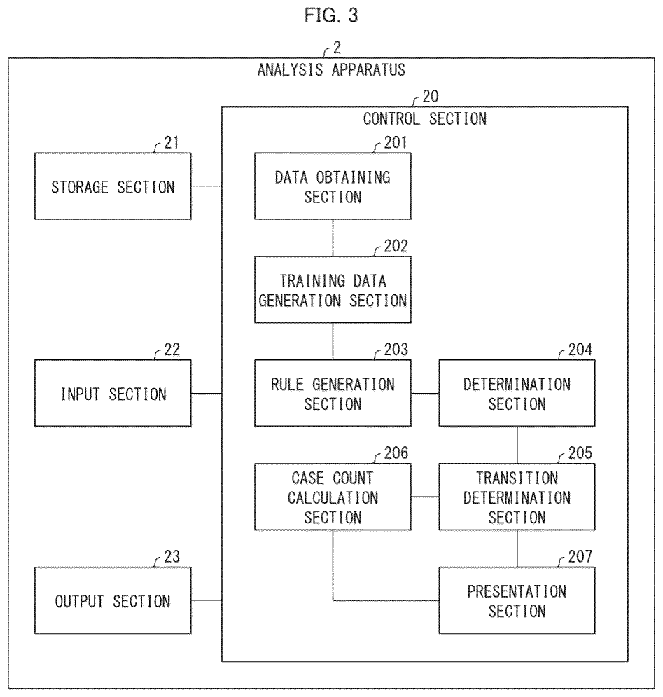

The following description will discuss the configuration of an analysis apparatus 2 with reference to FIG. 3. FIG. 3 is a block diagram illustrating an example of the configuration of the main part of the analysis apparatus 2. The analysis apparatus 2 is an apparatus that analyzes purchase history information of a subject. As illustrated in the figure, the analysis apparatus 2 includes a control section 20 that collectively controls sections of the analysis apparatus 2, and a storage section 21 that stores various kinds of data for use by the analysis apparatus 2. The analysis apparatus 2 also includes an input section 22 that accepts various kinds of data inputted into the analysis apparatus 2, and an output section 23 configured to output various kinds of data from the analysis apparatus 2.

Further, the control section 20 includes a data obtaining section 201, a training data generation section 202, a rule generation section 203, a determination section 204, a transition determination section 205, a case count calculation section 206, and a presentation section 207. The case count calculation section 206 will be described under the item “Chronological order of factors”.

The data obtaining section 201 obtains purchase history information indicative of histories of purchase behaviors of a plurality of subjects. As the purchase history information, the data obtaining section 201 may obtain, for example, data such as ID-POS (Point Of Sales) collected at a store to be subjected to analysis. The ID-POS is purchase history information associated with identification information (ID) of customers.

The training data generation section 202 generates training data for use in generation of a prediction rule for predicting the degree of change in purchase behavioral tendency of a subject. Then, the rule generation section 203 uses the training data generated by the training data generation section 202 to generate prediction rules each predicting the degree of change in purchase behavioral tendency of a subject. The training data and the prediction rules, and methods of generating them will be described under the items “Generation of training data” and “Generation of prediction rules”.

The determination section 204 determines, from purchase history information of a subject, a plurality of factors of change in purchase behavioral tendency of the subject based on purchase behaviors before and after the factors. Though described in detail later, the determination section 204 determines factors on the basis of predicted values indicated by the prediction rules generated by the rule generation section 203.

The transition determination section 205 determines the chronological order of the factors determined by the determination section 204. A method of determining the transition order of factors will be described under the item “Chronological order of factors”.

The presentation section 207 presents in chronological order the factors determined by the determination section 204. Here, the term “presentation” means that information is outputted in a manner recognizable by a subject of the presentation (typically, a user of the analysis apparatus 2). The form of the presentation only needs to allow a user of the analysis apparatus 2 to recognize the factors and its chronological order, and is not particularly limited. For example, the presentation section 207 may carry out presentation by causing any display device to display an image indicative of the factors and their chronological order. For example, in a case where this display device is the output section 23, the presentation section 207 may cause the output section 23 to output the image by displaying the image. Further, for example, the presentation section 207 may carry out the presentation by causing an audio output apparatus to perform voice output of the factors and its chronological order, or alternatively, may carry out presentation by causing a printing apparatus to print the factors and its chronological order. The presentation carried out by the presentation section 207 will be described with reference to specific examples under the items “First presentation example of factors” and “Second presentation example of factors”.

Similarly to the analysis apparatus 1 in accordance with the first example embodiment, the analysis apparatus 2 in accordance with the present example embodiment includes: the determination section 204 that determines, from behavior history information of a subject, a plurality of factors of change in behavioral tendency of the subject based on behaviors before and after the factors; and the presentation section 207 that presents in chronological order the factors determined by the determination section 204. This makes it possible to suitably ascertain the behavioral tendency of the subject. Further, the analysis apparatus 2 makes it possible to bring about a change in behavioral tendency (e.g., an increase in monthly purchase amount) by presenting in chronological order the factors determined by the determination section 204.

Specifically, the behavior history information for use in the present example embodiment is purchase history information indicative of histories of purchase behaviors of a plurality of subjects. In addition, the determination section 204 of the present example embodiment determines, on the basis of the behavior history information of the plurality of subjects, factors of change in purchase amount tendency common with the plurality of subjects.

Thus, the analysis apparatus 2 in accordance with the present example embodiment makes it possible to allow a user to recognize time-series factors that have caused purchase amount tendencies of subjects to change. Thus, the analysis apparatus 2 can achieve an example advantage of being capable of continuously increasing the purchase amount per predetermined period or terminating a continuous decrease in the purchase amount per predetermined period, in addition to the example advantage achieved by the analysis apparatus 1 in accordance with the first example embodiment.

### (Outline of Method for Determining Factor)

Causal inference, which is a technique for statistically analyzing causality, can be applied to determination of factors of change in behavioral tendency. For example, in potential outcome framework, which is a technique for the causal inference, a treatment effect t is defined as follows. Here, Y(1) indicates an outcome in a case where the treatment has been carried out, and Y(0) indicates an outcome in a case where the treatment has not been carried out. That is, the treatment effect is a degree of change in an outcome due to the treatment.

$$τ := Y ( 1 ) - Y ( 0 )$$

In a case where this technique is employed, the “treatment”, which brings about a desired change of the outcome, serves as a factor of change in behavioral tendency. As the outcome, an indicator value associated with a behavior and a tendency thereof, which are to be subjected to the analysis, may be applied. For example, in a case where an analysis is carried out to increase the loyalty of a customer, an outcome may be an amount of change in an indicator (e.g., a monthly purchase amount, monthly store visits, etc.) indicative of a degree of how good the customer is. This makes it possible to evaluate, for example, how a certain purchase behavior (corresponding to the abovementioned “treatment”) extracted from the purchase history information has changed the loyalty (outcome) of the customer.

Then, defining the relationship between the “treatment” and the outcome makes it possible to determine a treatment that increases the conditional average treatment effect (CATE), that is, a factor of change in behavioral tendency. Here, the CATE is an average treatment effect in a subpopulation satisfying a certain condition.

Although it is possible to extract a variety of “treatments” from the purchase history information, an outcome of the extracted “treatments” also varies from a desired to a non-desired one. Thus, it is necessary to extract a “treatment” that increases the CATE from the behavior history information. Although the details will be described later, according to the present example embodiment, a “treatment” that increases the CATE, that is, a factor of change in behavioral tendency, is determined by using a technique for generating a decision list that is one of rule-based models in which a plurality of simple conditions are combined.

### (Generation of Training Data)

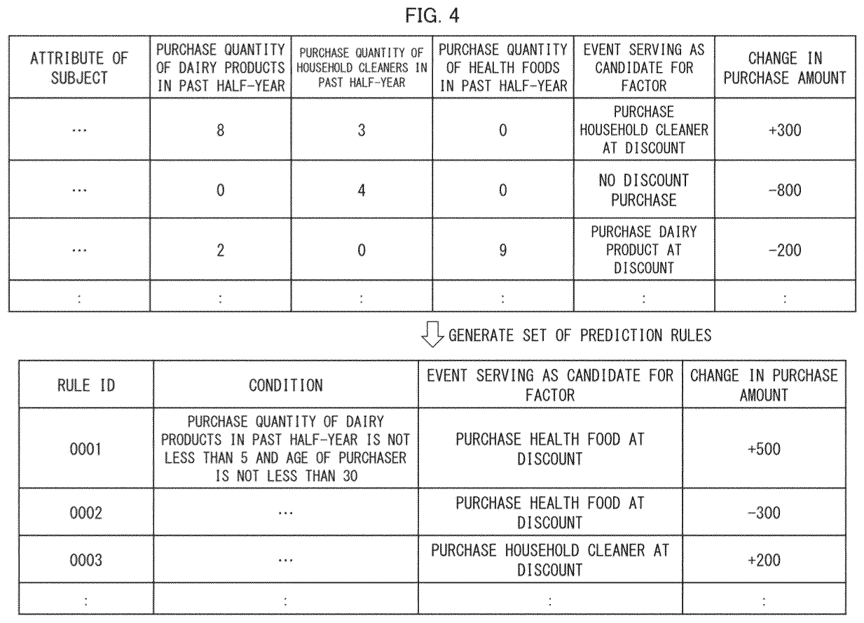

The following description will discuss, with reference to FIG. 4, generation of training data by the training data generation section 202 and generation of prediction rules by the rule generation section 203. FIG. 4 is a diagram illustrating an example of training data and prediction rules generated from the training data. Specifically, the upper part of FIG. 4 illustrates an example of the training data, and the lower part illustrates an example of the prediction rules. In this item, generation of training data will be described, and generation of prediction rules will be described under the item “Generation of prediction rules”.

The training data illustrated in FIG. 4 is data in which the attribute of a subject, the purchase quantity in each category in a predetermined period, an event serving as a candidate for a factor, and the change in purchase amount are associated. The training data generation section 202 generates such training data from purchase history information such as ID-POS.

Specifically, the training data generation section 202 first extracts, from purchase history information obtained by the data obtaining section 201, a plurality of events each serving as a candidate for a factor of an increase in purchase amount per predetermined period. Such an event to be extracted only needs to be an event that is likely to cause a change in the subject's purchase behavior, and an extraction method thereof is not particularly limited. For example, it can be thought that purchasing a product at a discount, browsing an advertisement for a particular application, or receiving a distributed coupon will cause a change in purchase behavior, so that the training data generation section 202 may extract such events from the purchase history information. Each of these “events” corresponds to the “treatment” in the potential outcome framework described above.

When extracting events in which products have been purchased at a discount, the training data generation section 202 may randomly extract the purchase of one product for each subject included in the purchase history information, and determine whether or not the purchase is made at a discount price. In carrying out this processing, the training data generation section 202 may generate, from the purchase history information, a list in which purchase histories are sorted by subject identification information (ID).

Then, when determining that the purchase is made at a discount price, the training data generation section 202 may determine a category of the purchased product, and extract as an event of “the product belonging to the determined category is purchased at a discount”. Thus, such an event that a product belonging to a predetermined product category is purchased at a discount, such as “purchase household cleaner at discount” and “purchase dairy product at discount” indicated in FIG. 4, is extracted as a candidate for a factor of an increase in purchase amount per predetermined period. Here, when determining that the purchase is not made at a discount price, the training data generation section 202 may extract as an event of “no discount purchase”.

Then, the training data generation section 202 extracts, from the purchase history information, information indicative of a feature of a subject who has undergone the extracted event at the time of occurrence of the event. For example, the training data generation section 202 may extract, from the purchase history information, the subject's age or age group, gender, occupation, family structure, residence or purchase price, residence type, workplace information, time or time slot of purchase, etc. FIG. 4 illustrates such information as “attribute of subject”.

Further, for example, the training data generation section 202 may generate, from the purchase history information, information indicative of a purchase situation of the subject who has undergone the extracted event at the time of occurrence of the event. Specifically, the training data generation section 202 may generate information indicative of the purchase quantity of a product belonging to a predetermined product category in the past half-year with respect to a time point of occurrence of the extracted event, and the generated information may be included in the training data, as illustrated in FIG. 4, for example. In addition, for example, the category, the name, the price, and the like of the purchased product may be included in the training data.

Then, the training data generation section 202 calculates an indicator value indicative of the degree of change in purchase behavioral tendency of the subject who has undergone the extracted event after the time point of occurrence of the event. For example, as in the example of FIG. 4, the training data generation section 202 may calculate, as the indicator value, a change in purchase amount in a predetermined period (e.g., a change in purchase amount per month). It can be said that the indicator value indicates a result yielded by the occurrence of the extracted event. It can also be said that the indicator value indicates what condition the occurrence of the extracted event brings the subject into. This “indicator value” corresponds to the “outcome” in the potential outcome framework described above.

### (Generation of Prediction Rules)

The rule generation section 203 uses the training data generated as described in the foregoing, to generate prediction rules each predicting the degree of change in purchase behavioral tendency of the subject after the occurrence of the event, specifically, the degree of change in purchase amount per predetermined period. Each of the prediction rules is a rule in which a condition is associated with a predicted value of the degree of change in purchase behavioral tendency after occurrence of an event of a subject who satisfies the condition. This predicted value corresponds to a predicted value of the “conditional average treatment effect” (CATE) in the potential outcome framework described above.

Such a prediction rule may also be generated, for example, with use of a general technique for generating a decision list. Specifically, first, the rule generation section 203 generates, for each “event serving as candidate for factor” in the training data shown in the upper part of FIG. 4, data indicative of a change in purchase amount in accordance with the occurrence or absence of the event (hereinafter referred to as “event-specific data”). For example, when generating the event-specific data of an event of “purchase household cleaner at discount”, the rule generation section 203 only needs to replace the item “event serving as candidate for factor” in the training data shown in the upper part of the FIG. 4 with an item indicating whether the event “purchase household cleaner at discount” has occurred. For example, assuming that “1” indicates that the event “purchase household cleaner at discount” has occurred and “O” indicates that the event has not occurred, “1” is placed only in the first row and “0” is placed in the remaining rows. This generates the event-specific data indicative of a change in purchase amount for each of two cases, that is, a case where an event “purchase household cleaner at discount” has occurred and a case where such an event has not occurred. Similarly, for another event, the rule generation section 203 generates event-specific data indicative of a change in purchase amount for each of two cases, that is, a case where the another event has occurred and a case where the another event has not occurred.

The event-specific data generated as described in the foregoing indicates the relationship between a covariate (feature at the time of event occurrence) x, an occurred event z, and a result y yielded when the event occurred. Thus, the rule generation section 203 can generate a decision tree for predicting the degree of change in purchase amount per predetermined period with use of these x, y, and z as input. The rule generation section 203 generates the decision tree for each event with use of the event-specific data for each event.

A method of generating the decision tree is not particularly limited. For example, since there are known techniques known as methods of generating a decision tree for predicting the conditional average treatment effect (CATE), it is possible to apply such techniques. Specifically, a decision tree may be generated with use of a technique such as Uplift Incremental Value Modelling (UpliftIVM), Squared t-Statistics Tree (t-stats), Uplift Decision tree (UpliftDT), Causal Inference Tree (CIT), and Causal Tree (CT), disclosed in “3.2.1 Tree-Based Methods” of the following literature.
Weijia Zhang, Jiuyong Li, and Lin Liu. 2021. “A unified survey of treatment effect heterogeneity modelling and uplift modelling” ACM Computing Surveys, Volume 54, Issue 8, November 2022, Article No. 162, pp. 1-36

Then, the rule generation section 203 generates a set of prediction rules from the decision tree generated as such. For example, the rule generation section 203 may assume a path from a root node to each leaf node of a decision tree to be a condition and generate a prediction rule by associating the condition with a predicted value at the leaf node (predicted value of the degree of change in purchase amount per predetermined period). According to this method, it is possible to generate L prediction rules from a decision tree with L leaf nodes. The rule generation section 203 generates the prediction rules in the foregoing manner for each event serving as a candidate for a factor.

By using the foregoing processing, it is possible to generate a set of prediction rules in which a condition, a predicted value of the degree of change in purchase amount per predetermined period, and an event serving as a candidate for a factor are associated with each other, as shown in the lower part of FIG. 4. As illustrated in FIG. 4, the generated prediction rules indicate various predicted values of the degree of change in purchase amount per predetermined period.

### (Determination of Factors)

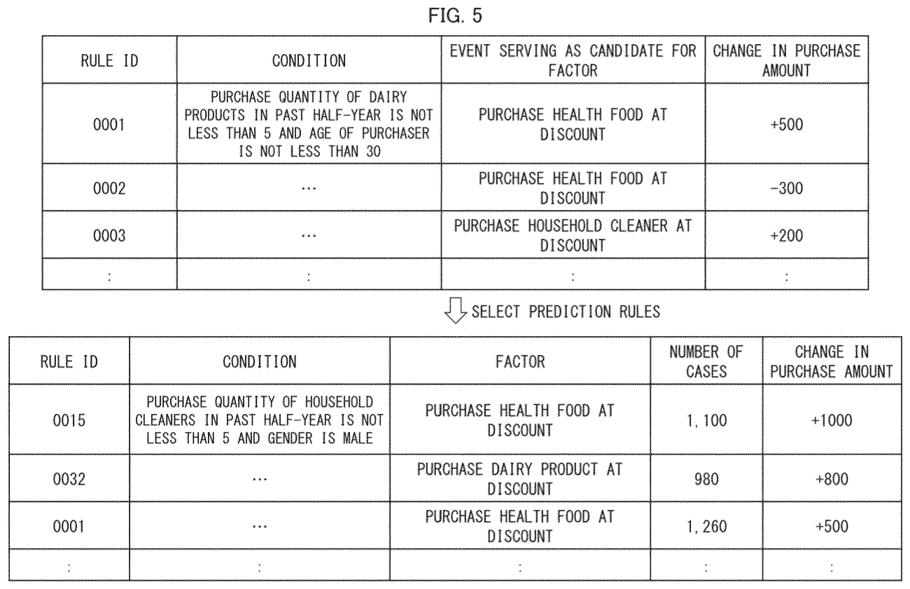

The following description will discuss a method of determining factors by using the prediction rules generated as described in the foregoing, with reference to FIG. 5. FIG. 5 is a diagram illustrating an example in which some prediction rules are selected from among a set of prediction rules. Here, the upper part of FIG. 5 illustrates a set of prediction rules (the same as shown in the lower part of FIG. 4), and the lower part illustrates prediction rules selected from the set.

As shown in the upper part of FIG. 5, each prediction rule includes an event that serves as a candidate for a factor, so that selecting a prediction rule results in selecting an event included in the prediction rule. The determination section 204 selects some prediction rules from among the set of prediction rules, to determine events included in the rules as factors of an increase in purchase amount per predetermined period.

Specifically, since each prediction rule includes a predicted value of the degree of purchase amount per predetermined period, the determination section 204 only needs to select prediction rules on the basis of the predicted values, that is, only needs to determine factors of an increase in purchase amount per predetermined period.

Specifically, the determination section 204 only needs to give priority to events each corresponding to a prediction rule having a relatively large predicted value of the degree of change in purchase behavioral tendency (specifically, the degree of change in purchase amount per predetermined period) when determining the events as the factors. Thus, it is possible to achieve an example advantage of being capable of determine an appropriate factor that can be expected to provide a greater degree of change in purchase behavioral tendency, in addition to the example advantage achieved by the analysis apparatus 1 in accordance with the first example embodiment. This also applies to any behavior other than the purchase behavior.

For example, the determination section 204 may determine, as the factors, events each corresponding to a prediction rule having a predicted value of the degree of change in purchase behavioral tendency of not less than a predetermined value set in advance. The predetermined value may be a fixed value, or may be an average value or the like of the predicted values in the generated prediction rules. Further, for example, the determination section 204 may determine, as the factors, events corresponding to a predetermined number of prediction rules each having a higher-rank predicted value of the degree of change in purchase behavioral tendency, among the generated prediction rules.

However, even in a prediction rule having a large predicted value of the degree of change in purchase behavioral tendency, if the number of cases that satisfies the condition is small, there is a possibility that an event included in the prediction rule may not be a factor of change in purchase behavior of most of the subjects. It should be noted that the number of cases that satisfy the condition may also be translated into the number of subjects who satisfy the condition.

Thus, the determination section 204 may give priority to events each corresponding to a prediction rule having a relatively large number of cases that satisfy the condition of the prediction rule, among purchase behavioral cases indicated in the purchase history information, when determining the events as the factors. Thus, it is possible to achieve an example advantage of being capable of determining an appropriate factor that can be expected to lead to a change in purchase behavioral tendency of more subjects, in addition to the example advantage achieved by the analysis apparatus 1 in accordance with the first example embodiment. This also applies to any behavior other than the purchase behavior.

For example, the determination section 204 may determine, as the factors, events each corresponding to a prediction rule having the number of cases that satisfy the condition of not less than a predetermined value set in advance, among purchase behavioral cases indicated in the purchase history information. The predetermined value may be a fixed value, or may be an average value or the like of the number of cases that satisfies the condition, included in the generated prediction rules. Further, for example, the determination section 204 may determine, as the factors, events corresponding to a predetermined number of prediction rules each having a higher-rank number of cases satisfying the condition, among the generated prediction rules.

As described in the foregoing, in the selection of the prediction rules (determination of factors), it is preferable to select, from the set including a large number of prediction rules, prediction rules covering as many subjects as possible and further having large predicted values of the degree of change in purchase behavioral tendency. Further, even if a plurality of similar prediction rules that apply to similar subjects are selected, it is impossible to determine a useful factor. For this reason, it is preferable to select prediction rules covering as many subjects as possible and having large predicted values of the degree of change in purchase behavioral tendency for respective subjects.

Thus, for example, the determination section 204 may decide a set of prediction rules each having a small value of loss calculated by using a loss function, and determine, as the factors, events corresponding to the respective prediction rules included in the set. Use of the loss function makes it possible to evaluate the appropriateness of a set including a plurality of prediction rules. Thus, it is possible to achieve an example advantage of being capable of determining a plurality of factors that are appropriate as a whole, in addition to the example advantage achieved by the analysis apparatus 1 in accordance with the first example embodiment. This also applies to any behavior other than the purchase behavior.

In addition, use of the loss function also makes it possible to decide a set including a small number of prediction rules having large predicted values of the degree of change in purchase behavioral tendency. For example, a loss function may be used that includes a term that is obtained by multiplying −1 by the sum of predicted values of the degree of change in purchase behavioral tendency in the prediction rules.

The lower part of FIG. 5 illustrates a set of prediction rules selected by the determination section 204. As illustrated in the figure, all of the predicted values of the change in purchase amount in the respective prediction rules shown in the lower part of FIG. 5 are not only positive values, but also large values. Thus, it can be said that each event included in these prediction rules is a factor that causes the purchase amount to increase.

Further, the prediction rules shown in the lower part of FIG. 5 also include the item “number of cases”. The number of cases is calculated by the case count calculation section 206. The case count calculation section 206 calculates, as the number of cases, the number of cases or subjects that satisfy the conditions indicated by the prediction rules. A factor included in a prediction rule that has a large number of cases and a large amount of change in purchase amount is considered to be a factor capable of greatly increase the purchase amount of a large number of subjects.

As described above, the analysis apparatus 2 includes the rule generation section 203 that generates a plurality of prediction rules for each of a plurality of events extracted from the purchase history information of a plurality of subjects and each serving as a candidate for a factor that causes the subject to change a purchase behavioral tendency, the prediction rules each predicting the degree of change in purchase behavioral tendency of the subject after occurrence of the event. Then, the determination section 204 determines a plurality of factors that are common with the plurality of subjects from among the plurality of events on the basis of the predicted values indicated in the prediction rules.

Thus, according to the analysis apparatus 2 in accordance with the present example embodiment, since the factors are determined based on the predicted values of the degree of change in purchase behavioral tendency of the subjects after occurrence of the events, it is possible to achieve an example advantage of being capable of determining a highly appropriate factor, in accordance with the example advantage achieved by the analysis apparatus 1 in accordance with the first example embodiment. This also applies to any behavior other than the purchase behavior.

It should be noted that, as described above, each prediction rule is generated based on the relationship between the occurred event z, the covariate x determined based on a purchase behavior carried out before the event z, and the result y determined based on a purchase behavior carried out after the event z. That is, since the prediction rule is generated based on the behaviors before and after occurrence of the event, it can be said that the determination section 204 that determines a factor by using this prediction rule determines a factor on the basis of behaviors before and after occurrence of the event.

### (Chronological Order of Factors)

The following description will discuss a method of determining the chronological order of the factors determined as described above. In determining the chronological order, first, the case count calculation section 206 divides the determined factors into groups, to extract cases that satisfy all the conditions corresponding to every factor in the groups. This processing may be carried out for each group that can be made from the determined factors. Further, this processing may be carried out on a group with two factors or a group with three or more factors. When the process is carried out on the group with two factors, the chronological order of two steps can be determined, and when the process is carried out on the group of three or more factors, the chronological order of three or more steps can be determined. Hereunder, an example in which, by using the group of two factor, the chronological order of the factors is determined will be described.

Next, the case count calculation section 206 classifies the cases extracted as described above in the order the events serving as factors occur. That is, the case count calculation section 206 classifies the cases that satisfy the conditions of two factors into two classes, that is, cases where an event of one factor occurred first and then an event of the other factor occurred, and a case where the events occurred in inverse order. The case count calculation section 206 calculates the number of cases of the classified cases.

Then, the transition determination section 205 ranks the factors on the basis of the number of cases calculated by the case count calculation section 206. For example, the transition determination section 205 may determine a class having the number of cases of not less than a predetermined threshold, and set the order that corresponds to the class as the order of factors. For example, assuming that the threshold is 10, the transition determination section 205 ranks factor A in order ahead of factor B, when the number of the cases where the condition of factor A is satisfied first and then the condition of factor B is satisfied is 100, and the number of the cases where the condition of factor B is satisfied first and then the condition of factor A is satisfied is 3. By carrying out such processing for each class, the transition determination section 205 can determine the chronological order of the factors determined by the determination section 204.

### (First Presentation Example of Factor)

The presentation section 207 presents in chronological order the factors determined as described above. The form of the presentation only needs to allow a user of the analysis apparatus 2 to recognize the factors and its chronological order, and is not particularly limited.

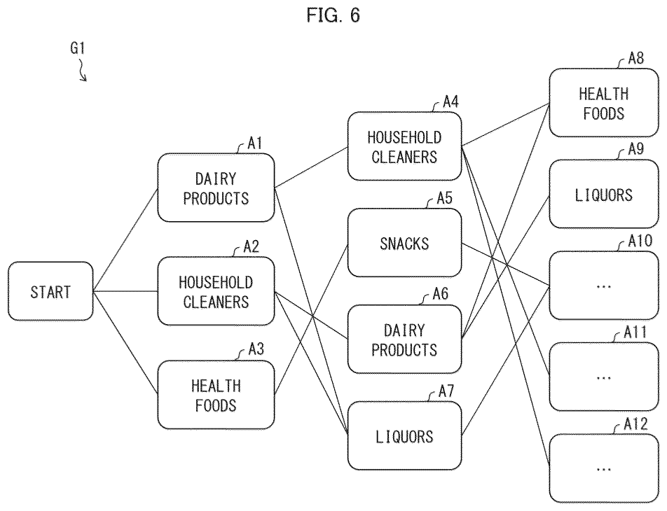

For example, the presentation section 207 may display a transition graph in which symbols representing the respective factors determined by the determination section 204 are connected in chronological order. FIG. 6 is a diagram illustrating a presentation example of factors. A transition graph G1 illustrated in FIG. 6 indicates the factors determined by the determination section 204 by respective rectangles with reference symbols A1 to A12, and indicates the chronological order of the factors by line segments connecting the rectangles A1 to A12. In the transition graph G1, the closer the factor is to a rectangle labeled with “START”, the earlier the factor occurs in the chronological order. The presentation section 207 can generate and display such a transition graph G1 by using the determination results given by the determination section 204 and the determination results given by the transition determination section 205.

For example, the rectangle A1 indicates a factor that a product in a category of dairy products is purchased at a discount, and the rectangle A4 indicates a factor that a product in a category of household cleaners is purchased at a discount. A line segment connecting the rectangles A1 and A4 indicates that the factor of the rectangle A4 occurs after the factor of the rectangle A1. Note that the presentation section 207 may display the number of cases where a transition indicated by a line segment has occurred, associating with the line segment. For this number of cases, those calculated by the case count calculation section 206 may be used.

Such a transition graph G1 can be suitably used for drafting an effective sales strategy or the like. For example, in the transition graph G1 of FIG. 6, the number of factors in the first stage, that is, the rectangles A1 to A3, are three. This indicates that, in order to make the purchase amount of a subject increase continuously, it is important to have the subject to purchase at the factors of the rectangles A1 to A3 at first.

Further, the transition graph G1 in FIG. 6 indicates that which factor is effective in the second stage depends on which factor has occurred in the first stage. For example, when the first-stage factor is a factor of the rectangle A1, the second-stage factor can be a factor of the rectangle A4 or A7, whereas when the first-stage factor is a factor of the rectangle A2, the second-stage factor can be a factor of the rectangle A6 or A7. Similarly, the transition graph G1 in FIG. 6 also indicates that which factor is effective in the third stage depends on which factor has occurred in the second stage.

Use of the transition graph G1 presented by the analysis apparatus 2 also makes it possible to effectively improve the customer loyalty by applying sales promotion measures in accordance with what factors the subject has gone through. For example, in a case where attention is paid to a route from the rectangle A1 to the rectangle A8 via the rectangle A4, a subject who does not have gone through any of the factors of these rectangles may be encouraged to buy a dairy product at a discount by, for example, distributing a discount coupon for dairy products. Further, a subject who has purchased a dairy product at a discount may be encouraged to purchase a household cleaner at a discount by, for example, distributing a discount coupon for household cleaners. A subject who has purchased a household cleaner at a discount may be encouraged to purchase a health food at a discount by, for example, distributing a discount coupon for health foods.

Further, use of the transition graph G1 also makes it possible to promote sales of products in a desired category. For example, it can be seen from the transition graph G1 that there are two routes leading to the rectangle A8 (health foods), that is, (rectangle A1)-(rectangle A4)-(rectangle A8) and (rectangle A2)-(rectangle A6)-(rectangle A8). Thus, from the transition graph G1, a measure to recommend purchasing dairy products and household cleaners at a discount can be derived as a measure to promote sales of health foods.

Note that, in the transition graph G1, each of the rectangles A1 to A12 may display information indicative of a prediction rule corresponding to the factor, instead of the factor per se. In this case, the transition graph G1 indicates a transition of the prediction rules. However, it is difficult for a user to recognize a factor by only prediction rules. Thus, when presenting information indicative of a transition of prediction rules, the presentation section 207 may, for example, present a factor corresponding to a prediction rule when the prediction rule is selected.

### (Second Presentation Example of Factor)

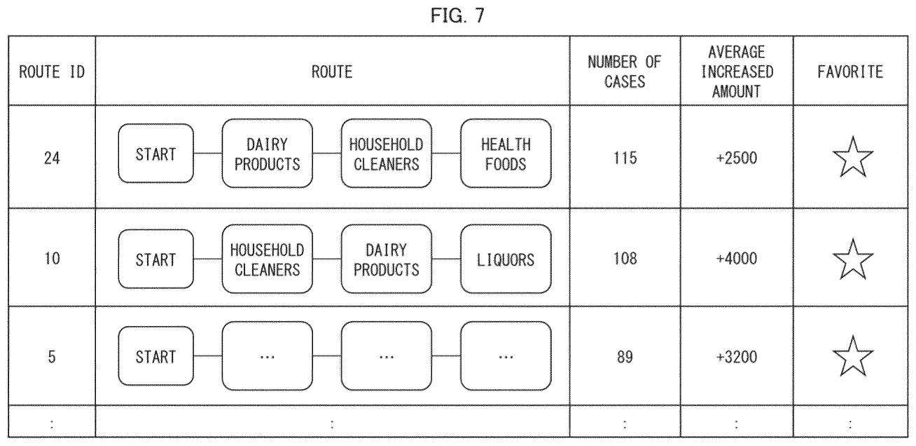

Since various transition routes of various factors are shown in the abovementioned transition graph G1, those routes may be extracted and presented individually. This will be described with reference to FIG. 7. FIG. 7 is a diagram illustrating another presentation example of factors.

The table illustrated in FIG. 7 includes items of route ID, route, the number of cases, average increased amount, and “favorite”. The presentation section 207 is configured to generate and display such a table by using the determination results of the determination section 204, the determination results of the transition determination section 205, and the calculation results of the case count calculation section 206.

The route ID is identification information that identifies a route of the transition of factors. The route indicates a plurality of factors and the transition order thereof. In the example of FIG. 7, similarly to the transition graph G1 of FIG. 6, a transition graph in which symbols representing the respective factors are connected in chronological order serves as information indicative of routes.

The number of cases indicates the number of cases where factors indicated in each route have been passed through in the transition order indicated by the route, and the number of cases is calculated by the case count calculation section 206. It is thought that a route with a larger number of cases is a more effective route for changing purchase behavioral tendencies of a large number of subjects.

In this manner, the determination section 204 may determine a plurality of factors that are common with the plurality of subjects based on purchase history information of the plurality of subjects, the analysis apparatus 2 may include the case count calculation section 206 that calculates the number of cases where the factors are passed through in chronological order, and the presentation section 207 may present the number of cases calculated by the case count calculation section 206. Thus, it is possible to achieve an example advantage of being capable of provide a user with a basis for determining the effectiveness of the combination of the factors in chronological order, in addition to the example advantage achieved by the analysis apparatus 1 in accordance with the first example embodiment.

The average increased amount is an average increased amount in purchase amount per predetermined period in a cases where the factors indicated in each route have been passed through in the transition order indicated by the route. It can be expected that, the higher average increased amount the route has, the more the route increases a purchase amount of a subject.

The item “favorite” is an item indicating whether the route is favored by a user of the analysis apparatus 2. The contents of the item “favorite” changes according to input into the analysis apparatus 2 made by the user. For example, for a route to which the user made an input to specify the route as a favorite, a star may be highlighted in the item “favorite”. By specifying, as a favorite, a route determined to be useful, the user can easily find out the route in a large number of routes, referring to the item “favorite”.

As described with reference to FIGS. 6 and 7, the presentation section 207 may display a transition graph in which symbols representing the respective factors determined by the determination section 204 are connected in chronological order. With this configuration, it is possible to achieve an example advantage of being capable of provide a user with factors and the chronological order thereof in a visually understandable manner, in addition to the example advantage achieved by the analysis apparatus 1 in accordance with the first example embodiment.

### (Flow of Processing)

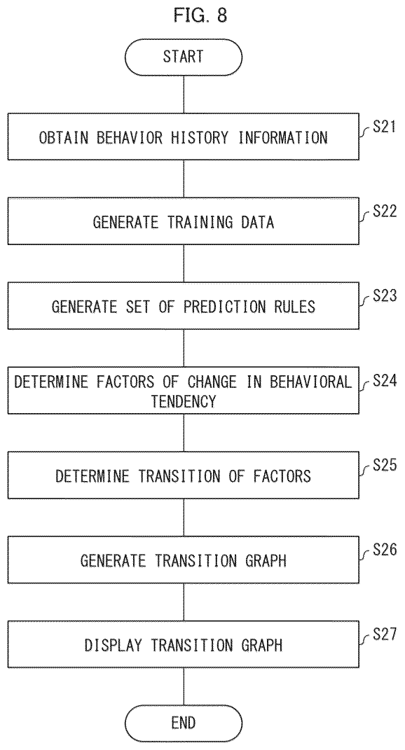

The following description will discuss the flow of the processing (analysis method) carried out by the analysis apparatus 2, with reference to FIG. 8. FIG. 8 is a flowchart illustrating an example of the processing carried out by the analysis apparatus 2.

In S21, the data obtaining section 201 obtains behavior history information indicative of the history of a behavior of a subject. For example, the data obtaining section 201 obtains purchase history information indicative of the histories of purchase behaviors of a plurality of subjects. The obtaining method is not particularly limited, and for example, the data obtaining section 201 may obtain the behavior history information that is inputted by a user of the analysis apparatus 2 through the input section 22.

In S22, the training data generation section 202 uses the input data obtained in S21 to generate training data for use in generation of prediction rules for predicting the degree of change in behavioral tendency of a subject. For example, the training data generation section 202 may generate training data for use in generation of prediction rules for predicting the degree of change in purchase amount per predetermined period of a subject. The method of generating training data is as described above in the item “Generation of training data”.

In S23, the rule generation section 203 generates a set of prediction rules by using the training data generated in S22. The method of generating a set of prediction rules is as described above in the item “Generation of prediction rules”.

In S24, the determination section 204 uses the set generated in S23 to determine a plurality of factors of change in behavioral tendency of a subject. For example, the determination section 204 may determine factors each causing the purchase amount of a subject to increase in a predetermined period. The method of determining factors is as described above in the item “Determination of factors”.

In S25, the transition determination section 205 determines the transition of the factors determined in S24, i.e., the chronological order of the factors. The method of determining the chronological order of the factors is as described above in the item “Chronological order of factors”.

In S26, the presentation section 207 generates a transition graph in which symbols representing the respective factors determined in S24 are connected in the chronological order determined in S25. The transition graph may be a tree diagram in which a plurality of routes of transitions are indicated in an at-a-glance fashion like the transition graph G1 of FIG. 6, or alternatively, the transition graph may individually indicates a transition for each route like the transition graph included in the table of FIG. 7.

In S27, the presentation section 207 presents in chronological order the factors determined in S25, by causing any display apparatus to display the transition graph generated in S26. This terminates the processing of the FIG. 8. Note that, as described above, the form of presentation performed by the presentation section 207 may be any form, and is not limited to the example in which a transition graph is displayed.

### [Variations]

The analysis apparatus 2 can be applied not only to analysis based on purchase history information as described above, but also to analysis based on various behavior history information. For example, use of service usage history information makes it possible to determine, for example, factors of improvement in the frequency of service usage by users of the service, factors of change in service plan, and the like.

Further, the analysis apparatus 2 may determine, based on behavior history information of a single subject, a plurality of factors of change in behavioral tendency of the subject, and may present the factors in chronological order. For example, by using the analysis apparatus 2, it is possible to determine, on the basis of training history information of a subject who works out in a gym, a plurality of factors of change in training frequency of the subject, and to present the factors in chronological order. This makes it possible to establish measures for improving training frequency that is customized for the subject. Similarly, it is also possible to present factors of restoring of the physical conditions or functions of a patient in a hospital or a user in a nursing care facility.

Any subject may carry out each process described in the above example embodiments, and is not limited to the examples described above. That is, an analysis system having functions similar to the functions of the analysis apparatus 2 can be constructed by a plurality of apparatuses that can communicate with each other. For example, an analysis system having the same functions as those of the analysis apparatus 2 can be constructed by dispersedly providing, in a plurality of apparatuses, respective blocks illustrated in FIG. 3.

### Software Implementation Example

Some or all of the functions of the analysis apparatuses 1 and 2 may be implemented by hardware such as an integrated circuit (IC chip), or may be alternatively implemented by software.

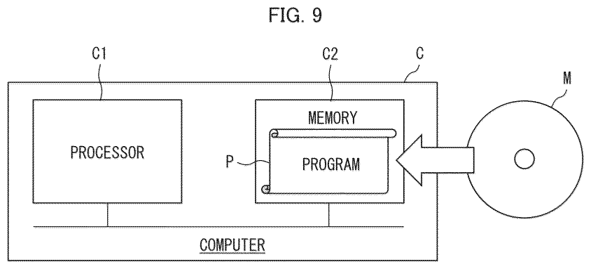

In the latter case, each of the analysis apparatuses 1 and 2 is implemented by, for example, a computer that executes instructions of a program that is software implementing the foregoing functions. FIG. 9 illustrates an example of such a computer (hereinafter referred to as “computer C”). The computer C includes at least one processor C1 and at least one memory C2. The memory C2 stores a program (analysis program) P for causing the computer C to operate as the analysis apparatus 1 or 2. The processor C1 of the computer C retrieves the program P from the memory C2 and executes the program P, so that the functions of the analysis apparatus 1 or 2 are implemented.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 may be, for example, a flash memory, a hard disk drive (HDD), a solid state drive (SSD), or a combination thereof.

Note that the computer C may further include a random access memory (RAM) in which the program P is loaded when the program P is executed and/or in which various kinds of data are temporarily stored. The computer C can further include a communication interface for carrying out transmission and reception of data with other apparatuses. The computer C may further include an input/output interface for connecting the computer C to an input/output apparatus(es) such as a keyboard, a mouse, a display and/or a printer.

The program P can be recorded in a non-transitory tangible storage medium M from which the computer C can read the program P. Such a storage medium M may be, for example, a tape, a disk, a card, a semiconductor memory, a programmable logic circuit, or the like. The computer C can acquire the program P via the storage medium M. The program P can also be transmitted via a transmission medium. The transmission medium may be, for example, a communications network, a broadcast wave, or the like. The computer C can acquire the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some or all of the example embodiments disclosed above can also be described as below. Note however that the present invention is not limited to example aspects described below.

### (Supplementary Note 1)

An analysis apparatus including: determination means for determining, from behavior history information of a subject, a plurality of factors of change in behavioral tendency of the subject based on behaviors before and after the factors; and presentation means for presenting in chronological order the factors determined by the determination means.

### (Supplementary Note 2)

The analysis apparatus according to Supplementary note 1, further including rule generation means for generating a plurality of prediction rules for each of a plurality of events extracted from the behavior history information of a plurality of the subjects and each serving as a candidate for a factor that causes the subject to change a behavior, the prediction rules each predicting a degree of change in behavioral tendency of the subject after occurrence of the event, the prediction rules each associating a condition and a predicted value of the degree of change in behavioral tendency after occurrence of an event of a subject who satisfies the condition, wherein the determination means determines a plurality of factors that are common with a plurality of the subjects from among a plurality of the events, based on the predicted values.

### (Supplementary Note 3)

The analysis apparatus according to Supplementary note 2, wherein the determination means gives priority to events each corresponding to a prediction rule having a relatively large predicted value when determining the events as the factors.

### (Supplementary Note 4)

The analysis apparatus according to Supplementary note 2 or 3, wherein the determination means gives priority to events each corresponding to a prediction rule having a relatively large number of cases that satisfy the condition among behavioral cases indicated in the behavior history information, when determining the events as the factors.

### (Supplementary Note 5)

The analysis apparatus according to any one of Supplementary notes 2 to 4, wherein the determination means decides a set of prediction rules each having a small value of loss calculated by using a loss function, and determines, as the factor, events corresponding to the respective prediction rules included in the set.

### (Supplementary Note 6)

The analysis apparatus according to any one of Supplementary notes 1 to 5, wherein the determination means determines a plurality of factors that are common with a plurality of the subjects based on the behavior history information of a plurality of the subjects, the apparatus further includes case count calculation means for calculating the number of cases where the factors are passed through in chronological order, and the presentation means presents the number of cases calculated by the case count calculation means.

### (Supplementary Note 7)

The analysis apparatus according to any one of Supplementary notes 1 to 6, wherein the presentation means displays a transition graph in which symbols representing the respective factors determined by the determination means are connected in chronological order.

### (Supplementary Note 8)

The analysis apparatus according to any one of Supplementary notes 1 to 7, wherein the behavior history information indicates histories of purchase behaviors of a plurality of the subjects, and the determination means determines a factor of change in purchase amount tendency common with a plurality of the subjects based on the behavior history information of a plurality of the subjects.

### (Supplementary Note 9)

An analysis method including: determining, by at least one processor, from behavior history information of a subject, a plurality of factors of change in behavioral tendency of the subject based on behaviors before and after the factors; and presenting, by the at least one processor, the determined factors in chronological order.

### (Supplementary Note 10)

An analysis program for causing a computer to function as: determination means for determining, from behavior history information of a subject, a plurality of factors of change in behavioral tendency of the subject based on behaviors before and after the factors; and presentation means for presenting in chronological order the factors determined by the determination means.

### [Additional Remark 3]

Further, some or all of the above embodiments can be expressed as below.

An analysis apparatus including at least one processor, the at least one processor carrying out: a determination process of determining, from behavior history information of a subject, a plurality of factors of change in behavioral tendency of the subject based on behaviors before and after the factors; and a presentation process of presenting in chronological order the factors determined in the determination process.

Note that the analysis apparatus may further include a memory, which may store therein a program for causing the at least one processor to carry out the determination process and the presentation process. The program may be stored in a computer-readable non-transitory tangible storage medium.

### REFERENCE SIGNS LIST

1, 2 Analysis apparatus
11, 204 Determination section
12, 207 Presentation section
20 Control section
21 Storage section
22 Input section
23 Output section
201 Data obtaining section
202 Training data generation section
203 Rule generation section
205 Transition determination section
206 Case count calculation section
C1 Processor
C2 Memory

What is claimed is:

1. An analysis apparatus comprising at least one processor, the at least one processor carrying out:
a determination process of determining, from behavior history information of a subject, a plurality of factors of change in behavioral tendency of the subject based on behaviors before and after the factors; and
a presentation process of presenting in chronological order the factors determined by the determination process.

2. The analysis apparatus according to claim 1, wherein
the at least one processor further carries out a rule generation process of generating a plurality of prediction rules for each of a plurality of events extracted from the behavior history information of a plurality of the subjects and each serving as a candidate for a factor that causes the subject to change a behavior, the prediction rules each predicting a degree of change in behavioral tendency of the subject after occurrence of the event, the prediction rules each associating a condition and a predicted value of the degree of change in behavioral tendency after occurrence of an event of a subject who satisfies the condition, and
in the determination process, the at least one processor determines a plurality of factors that are common with a plurality of the subjects from among a plurality of the events, based on the predicted values.

3. The analysis apparatus according to claim 2, wherein in the determination process, the at least one processor gives priority to events each corresponding to a prediction rule having a relatively large predicted value when determining the events as the factors.

4. The analysis apparatus according to claim 2, wherein in the determination process, the at least one processor gives priority to events each corresponding to a prediction rule having a relatively large number of cases that satisfy the condition among behavioral cases indicated in the behavior history information, when determining the events as the factors.

5. The analysis apparatus according to claim 2, wherein in the determination process, the at least one processor decides a set of prediction rules each having a small value of loss calculated by using a loss function, and determines, as the factor, events corresponding to the respective prediction rules included in the set.

6. The analysis apparatus according to claim 1, wherein
in the determination process, the at least one processor determines a plurality of factors that are common with a plurality of the subjects based on the behavior history information of a plurality of the subjects,
the at least one processor further carries out a case count calculation process of calculating the number of cases where the factors are passed through in chronological order, and
in the presentation process, the at least one processor presents the number of cases calculated by the case count calculation process.

7. The analysis apparatus according to claim 1, wherein in the presentation process, the at least one processor displays a transition graph in which symbols representing the respective factors determined by the determination process are connected in chronological order.

8. The analysis apparatus according to claim 1, wherein
the behavior history information indicates histories of purchase behaviors of a plurality of the subjects, and
in the determination process, the at least one processor determines a factor of change in purchase amount tendency common with a plurality of the subjects based on the behavior history information of a plurality of the subjects.

9. An analysis method comprising:
determining, by at least one processor, from behavior history information of a subject, a plurality of factors of change in behavioral tendency of the subject based on behaviors before and after the factors; and
presenting, by the at least one processor, the determined factors in chronological order.

10. A non-transitory storage medium storing an analysis program for causing a computer to carry out:
a determination process of determining, from behavior history information of a subject, a plurality of factors of change in behavioral tendency of the subject based on behaviors before and after the factors; and
a presentation process of presenting in chronological order the factors determined by the determination process.
